(19) United States
(12) Patent Application Publication
(10) Pub. No.: US 2004/0167915 A1
(43) Pub. Date: Aug. 26, 2004

(54) Systems and methods for declaratively transforming data objects between disparate representations

(75) Inventors: Arvind Sundararajan, San Jose, CA (US); Michael J. Carey, San Jose, CA (US)

Correspondence Address: FLIESLER MEYER, LLP, FOUR EMBARCADERO CENTER, SUITE 400, SAN FRANCISCO, CA, 94111, US

(73) Assignee: BEA Systems, Inc., San Jose, CA (US)

(21) Appl. No.: 10/784,376

(22) Filed: Feb. 23, 2004

Related U.S. Application Data
(60) Provisional application No. 60/450,082, filed on Feb. 25, 2003.

(51) Int. Cl. G06F 7/00

(52) U.S. Cl. 707/100

(57) ABSTRACT

A default shape representation can be used to transform data between formats having different shapes. The default shape representation can be made using a language with which a user is already familiar, such as XML. For example, a user may have XML data that the user wishes to use with a set of Java classes having a different shape. A user can simply apply an XML query language, such as XQuery, to translate the XML shape into the corresponding XML shape representation, and a query engine can take care of transforming the data to Java. A runtime component can then generate a Java object having that second shape. This allows a user to have and utilize a Java data structure using an XML language. Once users learn how to write a data transformation using XQuery, that user can use XQuery to transform XML to any other format, including another XML format.

This description is not intended to be a complete description of, or limit the scope of, the invention. Other features, aspects, and objects of the invention can be obtained from a review of the specification, the figures, and the claims.

### CLAIM OF PRIORITY

This application claims priority to U.S. Provisional Application 60/450,082 entitled “SYSTEMS AND METHODS FOR CONVERTING DATA TRANSFORMATIONS TO OBJECTS” by Sundararajan, et al., filed Feb. 25, 2003.

### CROSS-REFERENCED CASES

The following applications are cross-referenced and incorporated herein by reference:

U.S. Provisional Patent Application No. 60/376,906 entitled “COLLABORATIVE BUSINESS PLUG-IN FRAMEWORK,” by Mike Blevins, filed May 1, 2002;

U.S. Provisional Patent Application No. 60/377,157 entitled “SYSTEM AND METHOD FOR COLLABORATIVE BUSINESS PLUG-INS” by Mike Blevins, filed May 1, 2002.

U.S. Provisional Patent Application No. 60/450,074 entitled “SYSTEMS AND METHODS UTILIZING A WORKFLOW DEFINITION LANGUAGE” by Pal Takacsi-Nagy, filed Feb. 25, 2003.

### COPYRIGHT NOTICE

A portion of the disclosure of this patent document contains material which is subject to copyright protection. The copyright owner has no objection to the facsimile reproduction by anyone of the patent document of the patent disclosure, as it appears in the Patent and Trademark Office patent file or records, but otherwise reserves all copyright rights whatsoever.

### FIELD OF THE INVENTION

The present invention relates to transformations between data formats, such as for use in a workflow system.

### BACKGROUND

Many businesses have adopted the concept of workflows to automate business processes. A workflow generally refers to a software component that is capable of performing a specific set of tasks. These tasks are typically connected in a way that allows them to be ordered upon the completion of the tasks, which can include work items or other workflows. In a workflow, information such as files, documents, or tasks are passed between system resources according to a set of procedural rules so that the system can act upon the information.

Many existing business workflow systems utilize XML-based messaging. For example, a workflow system can receive an XML message, operate on that message using any of several different operations, and can send the operated-on message, as well as any other messages, to other resources in the system. In this example, a workflow is basically a business process management or automation system that can accept and output XML documents. In order to interact with other business components, such as J2EE-compatible components, there must be a way to transform from the XML data to the language of those components, such as Java for the J2EE components. For complete interaction, it is also necessary to transform back to an XML format. Various technologies exist for such data transformations, but these technologies are typically proprietary systems that require a user to learn a new language or technology. These technologies also have some inherent deficiencies, such as an inability to efficiently go both from XML to Java and from Java to XML.

### BRIEF SUMMARY

Systems and methods in accordance with the present invention provide for the transformation of data between formats having different shapes. A default shape representation can be made using a language with which a user is already familiar, such as XML. For example, a user may have XML data that the user wishes to use with a set of Java classes that have a different shape. A user can simply apply an XML query language, such as XQuery, to translate the XML shape into the corresponding XML shape representation, and a query engine can take care of transforming the data to Java. This allows a user to have and utilize a Java data structure using an XML language. Once users learn how to write a data transformation using XQuery, that user can use XQuery to transform XML to any other format, including another XML format.

Other features, aspects, and objects of the invention can be obtained from a review of the specification, the figures, and the claims.

### BRIEF DESCRIPTION OF THE DRAWINGS

FIG. 1A is a diagram of a shape mapping that can be used in accordance with one embodiment of the present invention.

FIG. 1B is a diagram of a shape mapping that can be used in accordance with one embodiment of the present invention.

FIG. 2 shows XML query code that can be used with the shape mapping of FIGS. 1A and 1B.

### DETAILED DESCRIPTION

Systems and methods in accordance with embodiments of the present invention overcome certain deficiencies in existing data transformation systems by taking advantage of a W3C standard query language called XML Query, or “XQuery.” XQuery is a language that can be used to specify queries over XML data. A query language such as XQuery can be used to describe the process of producing a piece of Java using an XML document, as well as going from Java to XML. An XML Query language, for example, can be used to specify mappings from XML to Java and from Java to XML. An XML query-processing engine can then be used to actually perform the mappings. As opposed to other techniques like JAXB, the use of XQuery can provide both ease of use and great flexibility in specifying how to extract data into non-trivial Java shapes from XML sources. Additionally, with this approach, multiple XML data sources as well as scalar values can be used to construct a single Java result object.

In order to perform the mappings, systems can take advantage of what is referred to herein as shape mapping. For instance, the system can determine the shape of a resulting Java object, and XQuery can specify a shape that maps onto the resulting Java object. The runtime can then take care of actually creating that Java object, with no further input from the user.

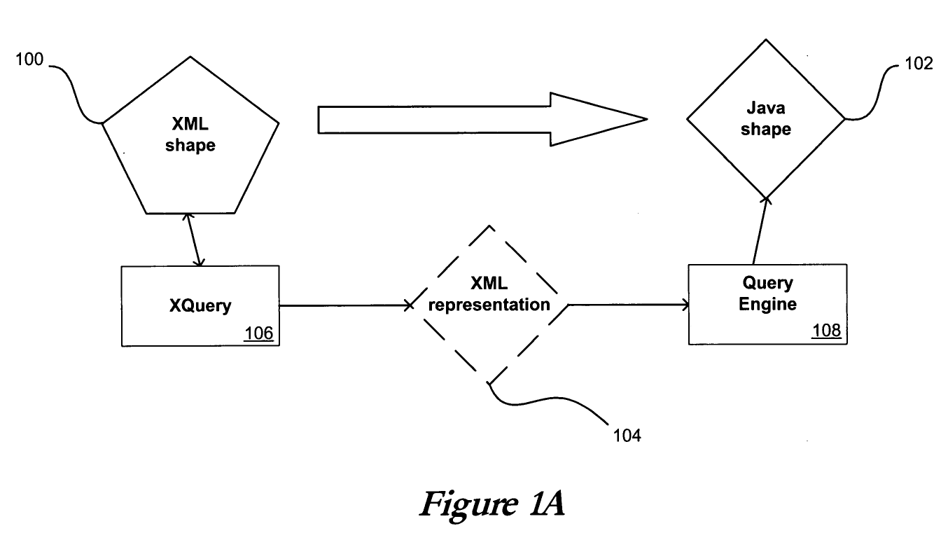

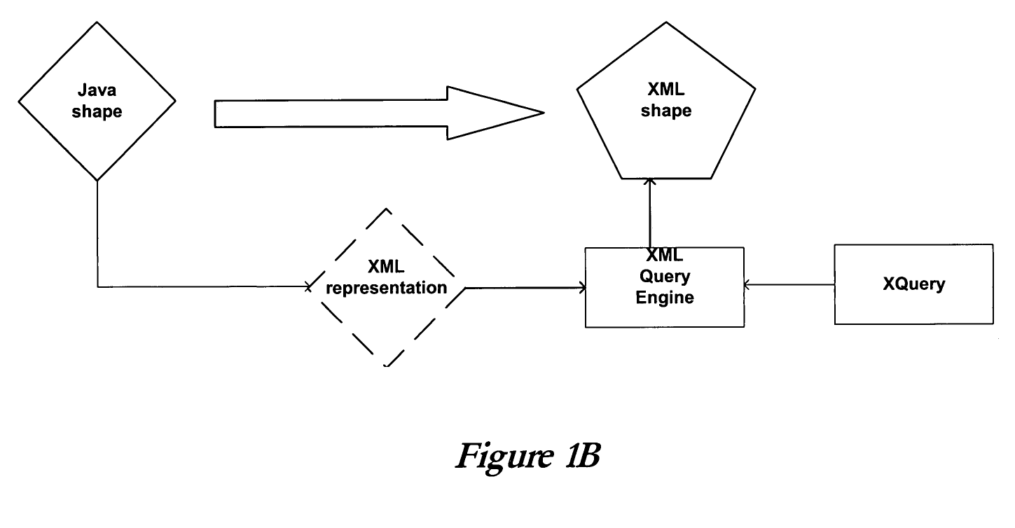

In an example situation shown in FIG. 1A, the user can start with XML data, having a particular XML shape 100, and may wish to be able to use that data with a set of Java classes that have a different shape, a Java-specific shape 102. As it is referred to herein, “shape” refers to the way in which data is laid out and structured. One way to get from a shape such as XML to a shape such as Java is to have a default shape representation with each Java shape, such as a default XML shape representation 104. For a given Java shape or XML shape, then, there is a corresponding shape in the other format. Rather than using a proprietary or system-specific language to do a transformation, this system simply uses languages with which a user is already familiar. The user can simply apply an XML query language, such as XQuery 106, to translate the XML shape into the corresponding XML shape representation, and a query engine 108 can take care of the default mapping or transforming of the data to Java. This allows a user to have and utilize a Java data structure using an XML language. Once users learn how to write a data transformation using XQuery, that user can not only use XQuery to transform XML to XML, but can use that same skill to transform XML to Java, or Java to XML. FIG. 1B shows the transformation of Java into XML in one embodiment.

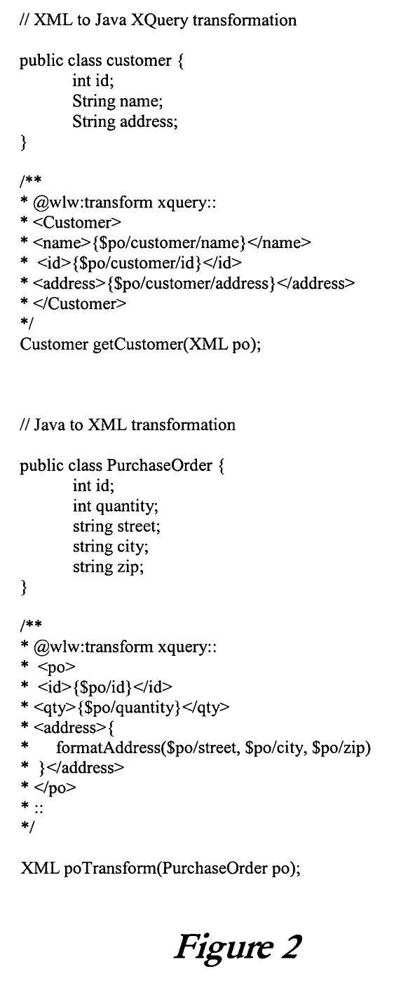

An example of XQuery code for the example of FIG. 1 is shown in FIG. 2. In this example, the customer data structure has an ID field, a name field, and an address field, each of which is a different type. The data that is being “returned” from the query in this example is basically a snippet of XML. The shape of that XML maps to the shape of the data structure and is generated by the XQuery engine.

Using XQuery for such transformations is also not limited to XML and Java, but can be used to transfer between any two shapes or data structures supported by an XQuery system. A user can even go from Java to Java using the same mechanism. For example, if a user starts with Java, the user would create the default XML shape first, from which the XML can be extracted. But the default XML shape is somewhat implicit, as the system does not internally generate any XML. A query-processing engine is used that produces results in an intermediate form, which can then be converted into Java objects. The conversion to and from the intermediate representation can be done in a streaming fashion, bit by bit.

In one example, a user may have an XML document containing purchase order information that the user would like to process with an order management system. The order management system, however, has a Java interface such that it only accepts certain Java objects. In order to process the purchase order, it is necessary to actually build the appropriate Java object(s). While products exist that can map from XML to Java, such as Castor or JAXP, these technologies do not map between any two structures. Further, each of these technologies utilizes a complicated, proprietary language instead of a simple XQuery language. Such an approach simplifies the user experience, as the user can already be familiar with XQuery, or a graphical tool that allows the user to create XQueries without actually knowing the language. A graphical tool can allow a user to simply draw some lines and create an XQuery. By drawing those same lines, the user can transform XML to Java, XML to XML, Java to XML, Java to Java, or between any other appropriate data structures.

There are many ways in which data structures can be specified in Java. While there are certain explicit structures, there are also structures referred to as map objects in Java. A map object is not an explicit, specified structure but is a map containing information such as keys and name-value pairs. This adds some additional functionality, as it can be possible, based on certain rules and depending on the shape of the XML, to map an entire subset of XML onto this Java map object map.

A transformation can be said to be attached to workflow, and can be referenced from within the workflow. A transformation can actually be a unit of different transformations that all are specified in a single file or object. When the workflow is compiled, the transformation file can then be pre-cached.

When the transformation code is compiled, the system can look at the Java data structure to determine approximately what the shape should look like, and store that information in what is referred to as a compiled plan, as well as information on the conversion of the XML. At compile time the compiled plan is created and stored for use at runtime, such that the conversion at runtime from the intermediate representation is much more efficient.

A system in one embodiment can utilize an engine that, given an XQuery specification, can generate a sequence of rules to be used in making the transformation. Once the user has this implicit mapping specified in a transformation, the system can look at the Java structure to determine the appropriate mechanism to go to or from that Java structure using the intermediate representation. Systems can support all Java shapes, or just a subset of Java shapes such as may include Java primitive types, collections, arrays, lists, and nested structures. If a system does not support all Java shapes, the system can recognize an unsupported shape at compile time and can reject the transformation at that point. Such a system can have some flexibility, however, as user-defined functions exist in XQuery that can provide some user-flexibility. XQuery can allow users to generate and utilize custom functions.

Business Process Management

Certain high-level requirements can exist for XML and Binary data handling user models used in business process management (BPM) systems. For example, a certain XML centricity can be required. BPM can involve receiving, storing, processing, and routing XML messages (and related data) in order to integrate pre-existing web services and backend application systems and thereby create new enterprise applications through system-level and component-level orchestration. BPM can support Binary data at its boundaries. BPM can be capable of receiving, storing, and routing Binary messages, and can be capable of transforming such messages into and out of XML for business processing purposes.

A W3C XML Query Language Recommendation provides a clean, concise, and declarative way to query, transform, and otherwise manipulate XML messages and data. This emerging standard, XQuery, can be the central textual language for data transformations and XML-based logic in BPM flows. A W3C XML Schema Recommendation is becoming widely accepted as the way to describe and validate XML data. A BPM can model must include strong support for handling typed XML data based on XML schema descriptions, or XSDs. An XSD, or XML Schema Description, is the XML-based language recommended by W3C for describing the data structures and data types expected in a given XML document type.

Customers of BPM systems can have pre-existing XSL files that are in use for performing XML transformations. It can be desirable for BPM systems to support XSLT so that legacy XSL transformations can be used in flows as well.

Also known as data integration, an XT system can be used to create binary data format descriptions, or binary schemas, together with mappings of these descriptions to their corresponding desired XML formats, and for the runtime translation between Binary and XML data based on these descriptions. A message format language (MFL) can be an XML-based language used by XT to capture and persist binary schemas and their associated XML mappings. The design-time component of XT can produce MFL files that are used to drive the XT runtime library data conversions.

Data Transformations Via Controls

A BPM system can use a control as the model for the packaging and inclusion of data transformations in a workflow. A given data transformation control can be a bundle of individual data transformations that can be called, such as during send or receive operations, from a workflow in which the control has been included. Various types of transformations can be supported by the data transformation control model, including XML to XML (XQuery), XML to Java (XQuery and some implicit mapping), XML to XML (XSL), Binary to XML (XT), XML to Binary (XT), and chains of transformations that start with Binary or XML data and end with either XML or Binary data.

The example transformation shown in FIG. 2(a), getCustomer, is an XQuery transformation that takes an XML input object and produces a Java object of class Customer as output. In this case, the XQuery used to define the control is expected to create an XML shape that matches the Java shape for Customer objects. XML elements are mapped to Java data members, or possibly Java-bean-like get/set function pairs, of the same name. This is an eminently reasonable thing to expect, as one purpose of the query can be to convert from the expected XML schema of some workflow variable to an intended Java shape. Having support for XQuery-based XML-to-Java data transformations makes it possible to use <perform> nodes in a workflow to marshall data from XML workflow variables into Java variables for use in calling “legacy” Java controls and other snippets of Java application functionality.

The next example transformation shown in FIG. 2(b), poTransform, shows how Java inputs can be converted to XML fragments of a different shape. In this example a Java function “formatAddress” is also used to customize the data format of certain fields of the Java data object.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for transforming between data shapes, comprising:
the use of a query language adapted to extract information from a first data shape and generate a representation of a second data shape; and
the use of a query engine adapted to generate the default mapping between the representation and the second data shape.

2. A system according to claim 1, wherein:
the query language is an XML query language.

3. A system according to claim 1, wherein:
at least one of the first and second data shapes is an XML data shape.

4. A system according to claim 1, wherein:
at least one of the first and second data shapes is a Java data shape.

5. A method for transforming between data shapes, comprising:
querying a first data shape to extract information from the first data shape and generate a representation of a second data shape; and
generating a default mapping between the representation and the second data shape.

6. A computer-readable medium, comprising:
means for querying a first data shape to extract information from the first data shape and generate a representation of a second data shape; and
means for generating a default mapping between the representation and the second data shape.

7. A computer program product for execution by a server computer for transforming between data shapes, comprising:
computer code for querying a first data shape to extract information from the first data shape and generate a representation of a second data shape; and
computer code for generating a default mapping between the representation and the second data shape.

8. A system for transforming between data shapes, comprising:
means for querying a first data shape to extract information from the first data shape and generate a representation of a second data shape; and
means for generating a default mapping between the representation and the second data shape.

9. A computer system comprising:
a processor;
object code executed by said processor, said object code configured to:
query a first data shape to extract information from the first data shape and generate a representation of a second data shape; and
generate a default mapping between the representation and the second data shape.

10. A computer data signal embodied in a transmission medium, comprising:
a code segment including instructions to query a first data shape to extract information from the first data shape and generate a representation of a second data shape; and
a code segment including instructions to generate a default mapping between the representation and the second data shape.
